(19) United States
(12) Patent Application Publication
(10) Pub. No.: US 2022/0222367 A1
(43) Pub. Date: Jul. 14, 2022

(54) DATA AGGREGATION FOR ANALYSIS AND SECURE STORAGE

(71) Applicant: Dilbot Financial Inc., Huntington Beach, CA (US)

(72) Inventor: Joseph Michael Walsh, Huntington Beach, CA (US)

(21) Appl. No.: 17/573,344

(22) Filed: Jan. 11, 2022

Related U.S. Application Data
(60) Provisional application No. 63/136,356, filed on Jan. 12, 2021.

(51) Int. Cl. G06F 21/62; G06F 21/60; G06F 16/25

(52) U.S. Cl. CPC G06F 21/6227; G06F 21/6245; G06F 2221/2141; G06F 16/258; G06F 21/602

(57) ABSTRACT

An online system may provide a method for aggregating raw data from a plurality of target entities into a blockchain using a common data schema. The online system identifies a data framework used by each target entity to store their raw data and generates data blocks for the blockchain based on the data framework used by each of the target entities.

### CROSS REFERENCE TO RELATED APPLICATION

This application claims priority to U.S. Provisional Patent Application No. 63/136,356, entitled “Computer-Implementable System and Method for Performing Uniform Financial Analyses and Diligence Across an Arbitrary Number of Unique Entities” and filed on Jan. 12, 2021, which is hereby incorporated by reference.

### BACKGROUND

An online system may store sensitive information for users of the online system. Those users may desire for third parties to have access to some of that sensitive information. However, users may provide data security or privacy rules to the online system that prohibit the online system from providing unlimited access to that information. Thus, conventional online systems face the problem of enforcing data security and privacy rules on the data stored by the online system for users while providing limited access to third parties.

Furthermore, a third-party user of an online system may want to analyze raw data stored on the online system by users where those third-party users have permission to access the user's information. However, the third-party user may experience difficulty analyzing the raw data if the raw data is stored in data frameworks used by the users who provide the data to the online system. This is because each user may use a different data framework, which makes it difficult for the third-party user to apply consistent data analysis processes across the data of different users.

### SUMMARY

An online system may provide a method for aggregating raw data from a plurality of target entities into a blockchain using a common data schema. The online system identifies a data framework used by each target entity to store their raw data and generates data blocks for the blockchain based on the data framework used by each of the target entities.

The method may include the steps of: receiving, at an online system, target entity raw data from a target entity, wherein the target entity raw data describes entity activities performed by the target entity; identifying, for the target entity, a data framework corresponding to the target entity raw data, wherein the data framework describes a structure of the target entity raw data; generating a data block based on the target entity raw data and the identified data framework, wherein the data block stores data from the target entity raw data in accordance with a common data schema; storing the data block in a blockchain, wherein the blockchain comprises a plurality of data blocks storing target entity raw data from a plurality of target entities; receiving an information request from an information client, wherein the information request identifies a data analysis process to perform one or more data blocks in the blockchain, wherein the one or more data blocks comprise the generated data block; generating data analysis results by performing the data analysis process on the one or more data blocks; and transmitting the data analysis results to the information client.

An example application of the disclosed online system is in the context of a borrower providing information to a lender. The online system may store information about the borrower and may provide only aggregated information to the lender in the form of results to data analysis processes.

### BRIEF DESCRIPTION OF THE DRAWINGS

FIG. 1 illustrates an example system architecture for an information system, in accordance with some embodiments.

FIG. 2 illustrates an example FDD system, in accordance with some embodiments.

FIG. 3 is a simplified diagram of an FDD system to perform data analyses on a number of target entities, in accordance with some embodiments.

FIG. 4 illustrates a simplified FDD system wherein the target entity is not an operating entity, in accordance with some embodiments.

FIG. 5 is a simplified illustration of an FDD system, in accordance with some embodiments.

FIG. 6 is an illustration of an FDD system wherein a number of Target Entities may be grouped into a number of subsets, in accordance with some embodiments.

FIG. 7 is a generalized illustration of an FDD system, in accordance with some embodiments.

FIG. 8 is a flowchart for a method of aggregating raw data from target entities, in accordance with some embodiments.

### DETAILED DESCRIPTION

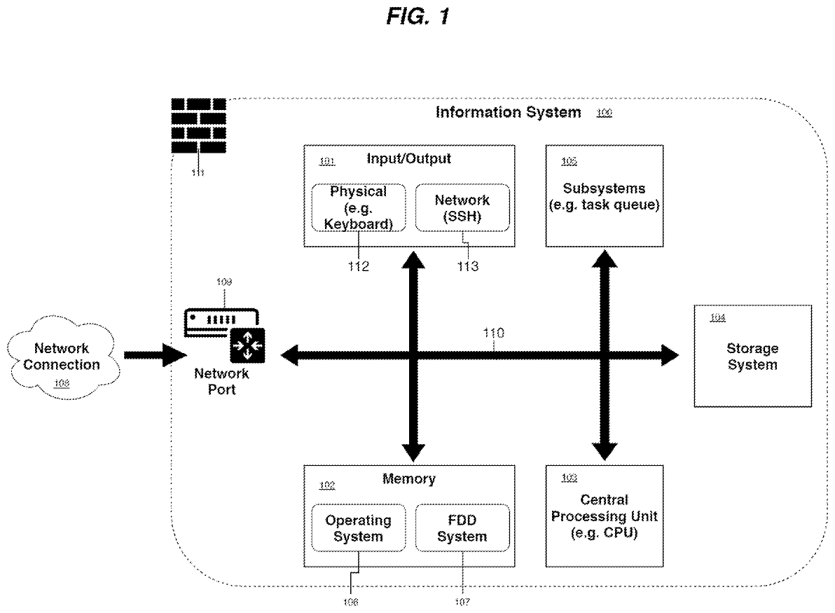

FIG. 1 illustrates an example system architecture for an information system, in accordance with some embodiments. Alternative embodiments may include more, fewer, or different components from those illustrated in FIG. 1, and the structure and functionality of each component may be divided between the components differently from the description below. Furthermore, the described functionality may be performed automatically or in response to a human input.

The information system 100 includes an input/output interface 101, system memory 102, a central processing unit (“CPU” or “processor”) 103, a storage system 104, and various subsystems 105. The input/output interfaces 101 in various embodiments may include physical interfaces 112 or network interfaces (e.g., secure shell (“SSH”) protocol) 113. The various subsystems 105 include a task queue, messaging system, or third-party provided services. System memory 102 includes an operating system 106, which may be a full or partially installed operating system, and a financial due diligence (or FDD) system 107. In some embodiments, the FDD system 107 is saved on a separate server to be accessed via a network connection 108 connected to the information system 100 via a network port 109, representing one or more interfaces capable of connecting with other information systems. The input/output interfaces 101, the memory 102, the CPU 103, the storage system 104, and the various subsystems 105 may communicate via data connections 110, which may be physical or via network port 109. In some embodiments, the information system 100 may include a secure environment 111, which may employ firewalls, whitelists, and other security methods.

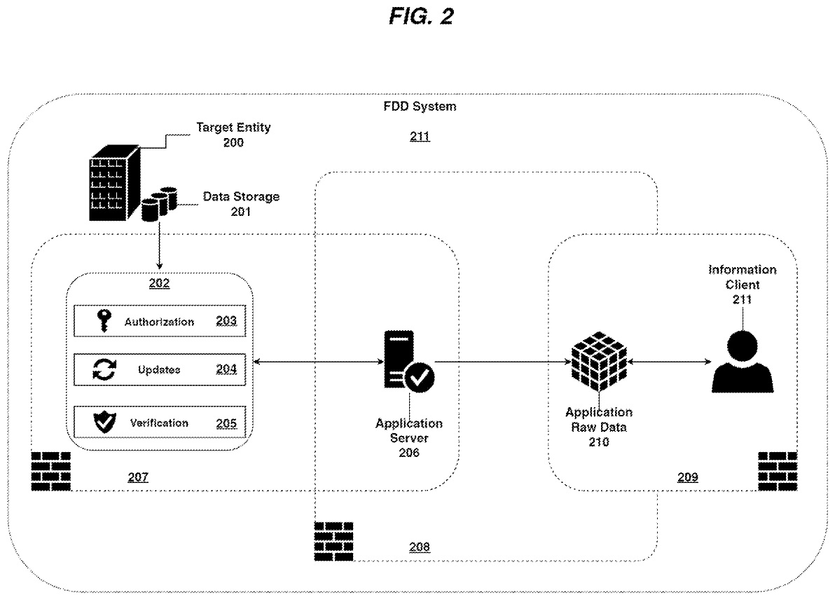

FIG. 2 illustrates an example FDD system 211, in accordance with some embodiments. Alternative embodiments may include more, fewer, or different components from those illustrated in FIG. 2, and the structure and functionality of each component may be divided between the components differently from the description below. Furthermore, the described functionality may be performed automatically or in response to a human input.

The target entity 200 is an entity whose raw data the FDD system 211 analyzes. For example, the target entity 200 may include a person, a business, or an organization. In some embodiments, the target entity is a third-party entity using the FDD system 211.

The target entity 200 may use an information technology system (“IT system”) for the purpose of recording information related to the target entity 200 and its actions, financial and otherwise, collectively referred to herein as “Entity Activities”. These IT systems store the “target entity raw data” created by said Entity Activities in one or more forms of data storage 201. The data storage 201, in various embodiments, may be at a physical location, owned and or operated by the target entity 200, or it may be on a server, physical or virtual, hosted by the target entity 200 or a third-party provider, and accessed via a network. The storage 201 is accessible remotely over a network in some embodiments, and in other embodiments it may be on a specific physical server.

The target entity 200 may use one or more IT systems, each having a separate data storage 201. The target entity 200 provides an FDD application server 206 with authorization 203 to access the target entity raw data. The authorization 203 may take different forms such as an encryption key, token, or other encryption standard as required by the specific implementation and configuration, and in some embodiments may include physical authorization (e.g. access to data restricted to the target entity's location). In some embodiments, the form of authorization may be providing a copy of the data storage 201, or a snapshot file from one or more of the target entity's IT systems. In some embodiments, the copy or snapshot file is an “accountant” copy or version. The form of authorization 203 also may be contractual or may not be required.

The FDD application server 206 performs an update 204 by obtaining the target entity raw data from the target entity data storage 201. The FDD application server 206 may obtain the target entity raw data by making a network request using secure protocols. The FDD application server 206 also may receive the target entity raw data from the target entity via secure file transfer protocol (“SFTP”), secure file upload, or saved on a computer medium (e.g. USB storage device) and provided physically.

In some embodiments, the FDD system 211 will perform additional verification 205, which may include cryptographic hash methods, digital signatures, or checksum files. The collective activities of authorization 203, updating 204, and verification 205 are collectively referred to as the “update process” 202. The update process 202 may occur within a secure digital environment 207, which in various embodiments will employ firewalls, whitelists, end-to-end encryption, and other security methods in accordance with the standards of those skilled in the art. The FDD system, shown in this embodiment hosted on application server 206, in various embodiments performs operations on the target entity raw data obtained from the target entity data storage 201, in order to store it as “application raw data” 210. The application raw data 210 in some embodiments may be saved in a relational database, non-relational database, a physical or virtual file system, or any combination of the foregoing or other data persistence methods known to those skilled in the art. In one embodiment the application raw data 210 is a block or a number of blocks of code containing instructions for the computer to retrieve the raw data 210. In one embodiment the target entity raw data from target entity data storage 201 may be directly used. The application server 206 and the application data 210 in various embodiments will operate within a secure environment 208 which in various embodiments will employ firewalls, whitelists, end-to-end encryption, and other security methods in accordance with the standards of those skilled in the art. Furthermore, in various embodiments, the Information Client 211 will use the FDD system to perform FDD analyses upon the application raw data 210 from within another secure environment 209, which in various embodiments will employ firewalls, whitelists, end-to-end encryption, and other security methods in accordance with the standards of those skilled in the art. Furthermore, in various embodiments the secure environments 207, 208, 209 may be one connected secure network, or a number of secure connected networks, or a combination thereof. In some embodiments one or more of the secure environments 207, 208, 209 may not be required by the FDD system implementation.

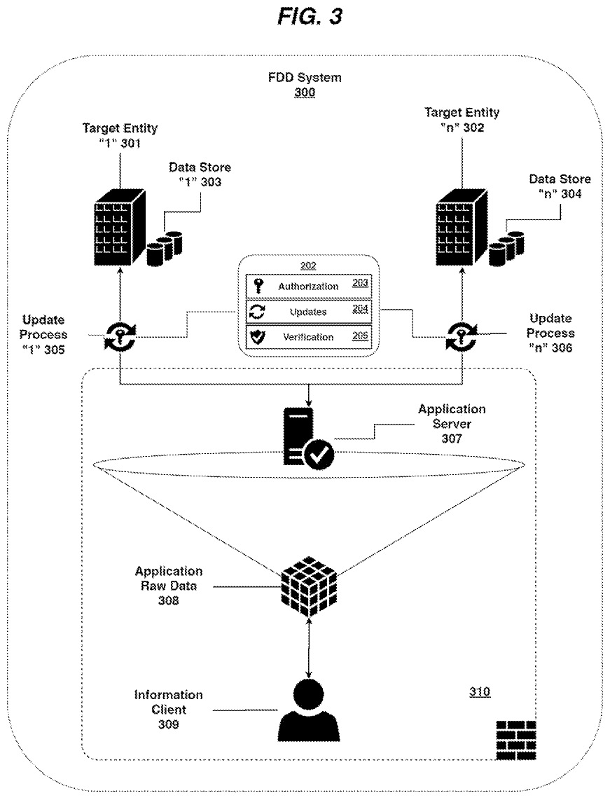

FIG. 3 is a simplified diagram of an FDD system 300 in accordance with an embodiment of the present invention to perform FDD on a number of Target Entities “1” 301 through “n” 302. Furthermore, in various embodiments the Target Entities “1” 301 through “n” 302 have various IT systems, recording target entity raw data in data stores “1” 303 through “n” 304. In various embodiments there may be varying numbers of IT systems and data storage schemes per target entity, pursuant to the descriptions and various embodiments described herein. In various embodiments the Target Entities “1” 301 through “n” 302 will perform update processes “1” 305 through “n” 306, which include the various embodiments of authorization 203, updates 204, and verification 205, collectively the general update processes 202, with the application server 307, which may be one or more physical servers under the physical control of target entity “1” 301 through “n” 302, the Information Client 309, or a third party authorized by either the Target Entities “1” 301 through “n” 302 or the Information Client 309, or some combination thereof. In various embodiments the application server 307 performs operations on the target entity raw data in data stores “1” 303 through “n” 304 to generate application raw data 308. In various embodiments the FDD system 300 is within a secure environment 310, which in various embodiments will employ firewalls, whitelists, end-to-end encryption, and other security methods in accordance with the standards of those skilled in the art.

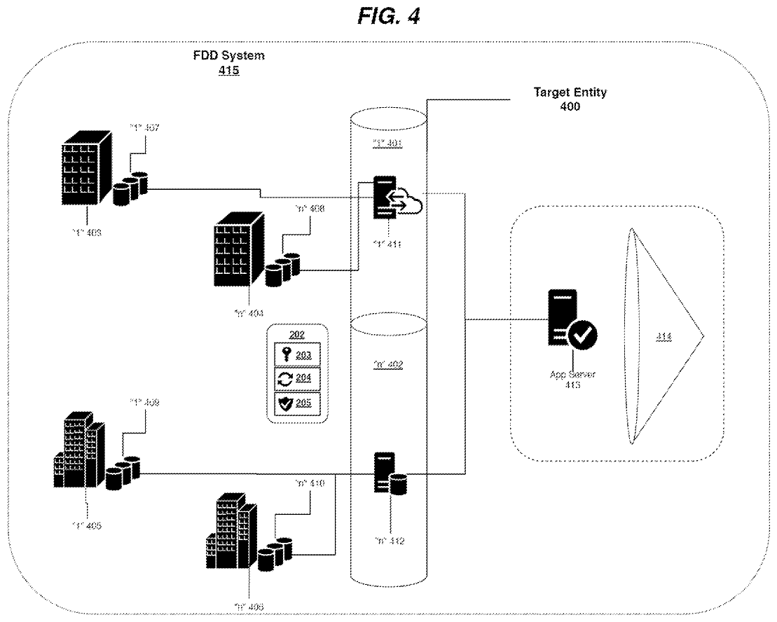

FIG. 4 illustrates a simplified FDD System 415, in accordance with various embodiments of the present invention wherein the target entity 400 is not an operating entity, but includes some number of “sub-sections” or “tranches” “1” 401 through “n” 402, such that the performance of said tranches being derived from the performance of one or more “base entities”. In this diagram, the performance of the target entity's 400 section “1” 401 is derived from base entities “1” 403 through “n” 404 and the performance of the target entity's 400 sub-section “n” 402 being derived from base entities “1” 405 through “n” 406. This diagram is meant to show in general an embodiment wherein the target entity is not an operating company but an entity whose performance derives from the performance of other operating entities, and should not be understood to be limiting in the number of combinations of sub-sections and base entities. In various embodiments, the base entities “1” 403 through “n” 406 will employ various IT systems and storage schemes “1” 407 through “n” 410, which may use various methods of organizing and storing the data as discussed above. In various embodiments the base entities “1” 403 through “n” 406 will perform the general update processes 202 with a set of intermediary servers “1” 411 through “n” 412, which in turn will general update processes 202 with a set of intermediary servers “1” 411 through “n” 412 with the primary application server 413, while in other embodiments the base entities “1” 403 through “n” 406 will general update processes 202 with a set of intermediary servers “1” 411 through “n” 412 with the primary application server 413. Further embodiments may use some subset or combination of subsets of the general update processes 202 with a set of intermediary servers “1” 411 through “n” 412. In various embodiments the application server may perform operations on the raw data, may store the raw data according to the application storage scheme pursuant to the various embodiments discussed above in FIG. 1 through FIG. 4, and may update Information Client, the foregoing represented in this diagram by 414.

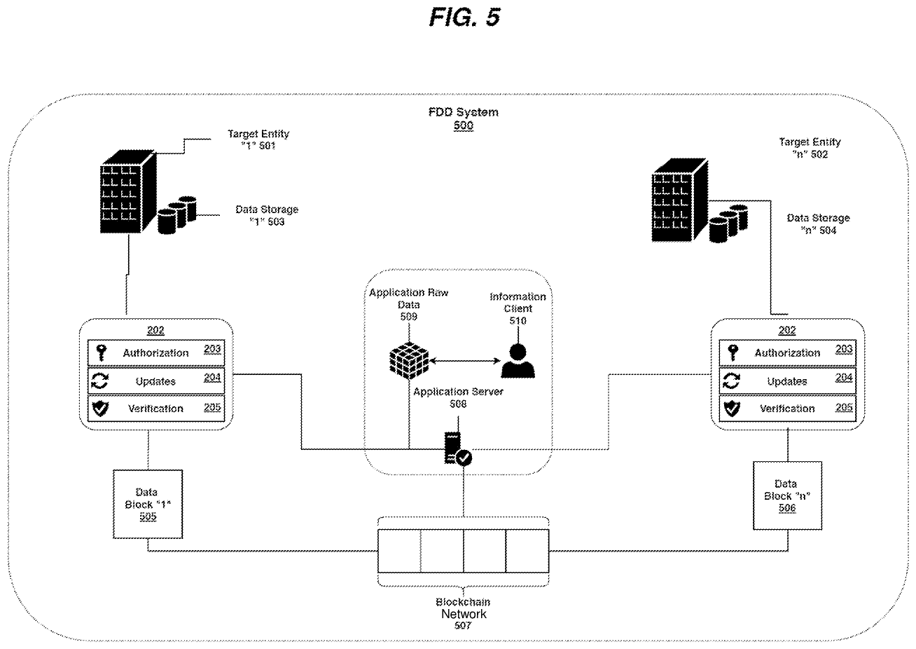

FIG. 5 is a simplified illustration of an FDD system 500 showing an implementation of the present invention according to some embodiments. These embodiments may implement the FDD system 500 to perform financial analysis and FDD on a target entity or Entities “1” 501 through “n” 502 on a real time basis. Various embodiments of the present invention may store data pertaining to the Target Entities “1” 501 through “2” 502 and the Entity Activities thereof, in a blockchain 507. In various embodiments, after the Target Entities “1” 501 through “n” 502 perform the update process 202, communicating with the application server 508, in various embodiments authorization 203 may occur on a recurring basis (e.g. daily), and in various embodiments the updates 204 may occur on a recurring basis that may or may not be the same as that of the authorization 203. In various embodiments, as shown in general in FIG. 5, the verification 205 step will store the target entity raw data from Target Entities “1” 501 through “n” 502 into one or more Data Block “1” 505 through “n” 506, which are appended to a blockchain in blockchain network 507. The application server 508, in various embodiments may perform as a node in the blockchain network 507, performing authentication and verification of each block added to the blockchain. Furthermore, in various embodiments each target entity “1” 501 through “n” 502 may employ a number of application servers such that there are “n” number of application servers 508, each participating in the blockchain network 507 and providing additional processing capacity to authenticate and verify each new block added to the blockchain network 507. This authentication performed by each of the nodes in the blockchain network 507, can only allow new data updates into the blockchain by a majority of positive verifications, preventing the data in Data Blocks “1” 505 through “n” 506 from being subsequently altered without a record of said alteration. In some embodiments the information stored in Data Blocks “1” 505 through “n” 506 will be encrypted before being stored in said blocks, with the key, token, or other means of decryption, referred to in this discussion of FIG. 5 as “key,” provided to the application server 508, such that the other nodes in the blockchain network 507, are able to verify that the data in said Data Blocks “1” 505 through “n” 506 has or has not been tampered with or otherwise altered, without being able to view the unencrypted target entity raw data. The FDD system 500 on application server 508 is able to provide FDD functionality, creating an application raw data store 509, and enabling the Information Client 510 means to FDD analysis and reports, on the unencrypted target entity raw data via the key provided in the update process 202. In various embodiments the number of application servers 508 may vary depending on the number of Target Entities “1” 501 through “2” 502, and the number of application servers 508 may not necessarily equal the number of Target Entities “1” 501 through “n” 502.

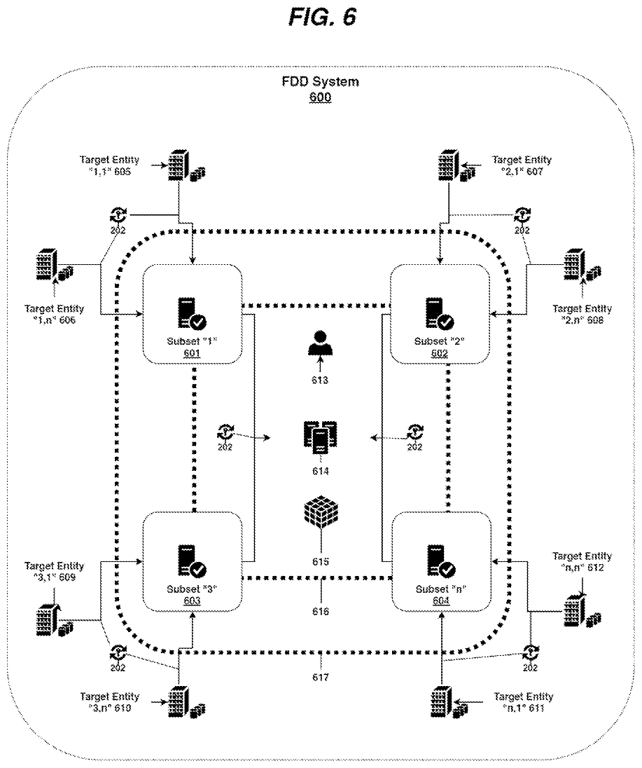

FIG. 6 is an illustration of an FDD system 600 implemented according to an embodiment of the present invention wherein a number of Target Entities “1,1” 605 through “n,n” 612, which in various embodiments as shown in FIG. 6 may be grouped into a number of subsets “1” 601 through “n” 604, such that Target Entities “1,1” 605 through “1,n” 606, are grouped into subset “1” 601, Target Entities “2,1” 607 through “2,n” 608 are grouped into subset “2” 602, Target Entities “3,1” 609 through “3,n” 610 are grouped into subset “3” 603, and Target Entities “n,1” 611 through “n,n” 612 are grouped into subset “n” 604. In various embodiments the Target Entities “1,1” 605 through “n,n” 612 and their respective subsets “1” 601 through “n” 604, may be related by a common Information Client 613, said Information Client 613 desiring to perform FDD upon any of the Target Entities “1,1” 605 through “n,n” 612, any of the subsets “1” 601 through “n” 604, or some combination of some or all of the above in a consistent and uniform manner via the FDD system 600. Referring to FIG. 6, the update process 202 is used herein to represent the various embodiments of the update process 202 as described above and herein. In various embodiments, and as shown here in FIG. 6, the Target Entities “1,1” 605 through “n,n” 612, may perform the update process with specific application servers dedicated to the respective subsets “1” 601 through “n” 604. In some embodiments the specific application servers dedicated to the respective subsets “1” 601 through “n” 604 may perform the update process with a general application server 614, while in other embodiments the Target Entities “1,1” 605 through “n,n” 612, may perform the update process directly with the general application server 614. The general application server 614 in various embodiments will maintain application raw data in a data store 615. In various embodiments implementing a blockchain to validate and store data, the Target Entities “1,1” 605 through “n,n” 612, may, via various methods described in this disclosure, store data in a blockchain 617. In other embodiments there may be other blockchains representing one or more subsets “1” 601 through “n” 604, which may store data in a blockchain 616. The illustration is not meant to be limiting, as those skilled in the art will realize that the number and exact nature of groupings will depend on the nature of the FDD system and FDD being performed. Various embodiments may implement encryption before storing data in a blockchain, such that all of the nodes in the blockchain system can test all of the blocks for evidence of tampering, without being able to access the data itself. As an example, Information Client 613 may require an analysis showing the account balances of Target Entities “1,1” 605 through “n,n” 612 at a certain date, as a consolidated entity, as a set of consolidated entities corresponding to subsets “1” 601 through “n” 604, or any combination thereof, the analysis based upon application raw data 615, having been validated by one or more blockchains 616 and 617, while preventing any one blockchain node from accessing the data of another.

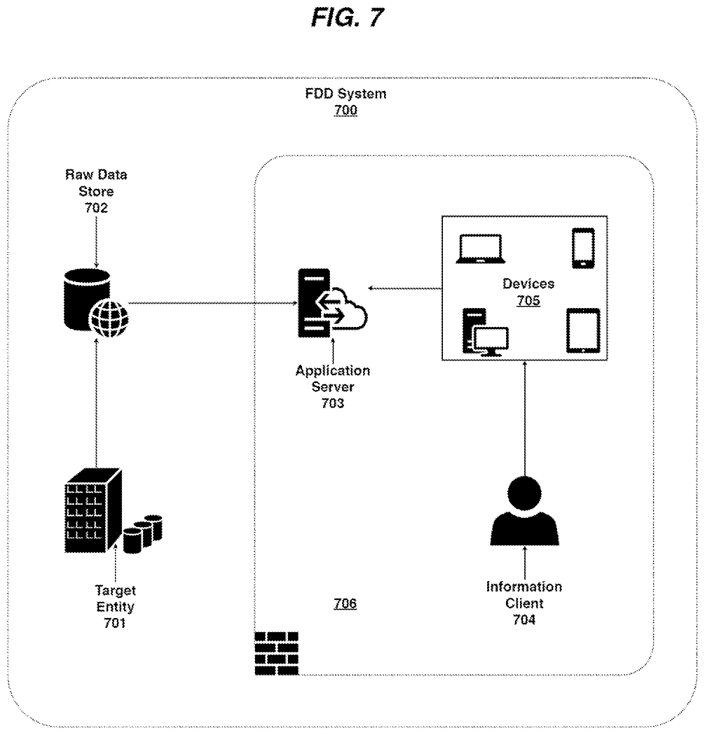

FIG. 7 is a generalized illustration of an FDD system 700, in accordance with some embodiments. A target entity 701 utilizes cloud based IT systems to perform accounting practices, with the raw data store 702 operated by a third party service provider. In various embodiments such as the one shown in FIG. 7 the Application Server 703 will be operated by the Information Client 704, and accessed from a number of devices 705, within the Information Client's 704 secure environment 706. In various embodiments the devices 705 may include personal computers, laptops, tablets, phones/smart-phones, or another network connectable device. Those with skill in the art will recognize that there are many such devices, and this listing is not meant to be limiting in scope. In many preferred embodiments the choice of secure environment 706 may require additional security measures on said devices 705, such as multiple factor authentication, and other devices security measures as known to those skilled in the art.

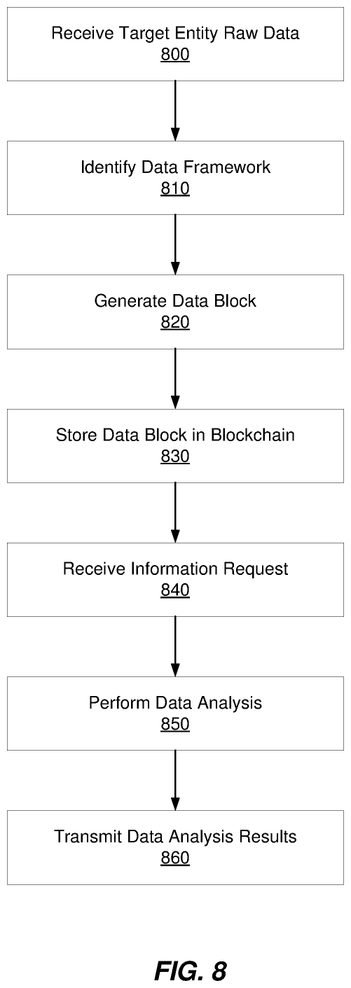

FIG. 8 is a flowchart for a method of aggregating raw data from target entities, in accordance with some embodiments. Alternative embodiments may include more, fewer, or different steps from those illustrated in FIG. 8, and the steps may be performed in a different order from that illustrated in FIG. 8. Additionally, each of these steps may be performed automatically by an online without human intervention.

An online system receives 800 target entity raw data from a target entity. The target entity raw data describes entity activities performed by the target entity. For example, the target entity raw data may include transactions taken by the target entity. The target entity raw data may also include sales data, purchase data, bill payment data, customer receipt data, deposit or withdrawal data, accrual data, adjustment data, or journal entries.

The online system identifies 810 a data framework used by the target entity to store its raw data. A data framework describes a structure in which the target entity stores its raw data. For example, the target entity may use a data framework from QuickBooks, NetSuite, FreshBooks, or any other accounting software. The target entity raw data may indicate a data framework used by the target entity. The online system may store an identifier for the data framework used by the target entity in a lookup table that associates the data framework with the target entity. In some embodiments, the online system identifies the data framework used by the target entity by analyzing the target entity raw data received from the target entity.

In some embodiments, the online system identifies the data framework used by the target entity when the online system first receives the target entity raw data and generates a mapping of fields used by the data framework to fields used by a common data schema used by the online system. The online system may generate the mapping based on similarities of the fields used by the data framework and the fields used by the common data schema, common substitutes for fields used by the data framework, reports stored in the target entity raw data, a general ledger stored in the target entity raw data, or account names in the target entity raw data. In some embodiments, the online system uses a machine-learning model (e.g., a neural network) to generate the mapping. The machine-learning model may be trained based on data generated by a computer-simulation of a target entity.

The online system generates 820 a data block based on the received target entity raw data and the data framework used by the target entity. The data block stores the target entity raw data in accordance with a common data schema. The online system may generate a mapping of fields from the data framework to fields in the common data schema and may generate the data block based on the mapping. The online system stores 830 the data block in a blockchain that stores data blocks generated based on target entity raw data received from a plurality of target entities.

The online system receives 840 an information request from an information client. The information request may identify one or more data analysis processes to perform on data blocks stored in the block chain. For example, the information request may identify data analysis processes such as a field exam analysis, a cash-flow analysis, a quality of earnings analysis, an aging report analysis, an inventory report analysis, a gross profit analysis, a turnover report analysis, a financial statement analysis, a sales analysis, or an expenses analysis. In some embodiments, a data analysis process may perform a data analysis process on data blocks storing data from one or more target entities. The online system performs 850 the identified data analysis processes on data blocks stored in the blockchain and generates data analysis results based on the data analysis processes. The online system then transmits 860 the data analysis results to the information client.

In some embodiments, the online system enforces a layered permission process by limiting the data within the blockchain that can be accessed by the information client. For example, the online system may store certain permissions that limit the access of sets of data within the blockchain to certain information clients, and may limit the data analysis processes that the information client can request based on whether the data analysis process would require the online system to provide prohibited information to the information client.

### Additional Considerations

The foregoing description of the embodiments has been presented for the purpose of illustration; it is not intended to be exhaustive or to limit the patent rights to the precise pages disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some embodiments, a software module is implemented with a computer program product comprising one or more computer-readable media containing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media.

Embodiments may also relate to an apparatus for performing the operations herein. This apparatus may be specially constructed for the required purposes, or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition A or B is satisfied by any one of the following: A is true (or present) and B is false (or not present), A is false (or not present) and B is true (or present), and both A and B are true (or present).

What is claimed is:

1. A method comprising:
receiving, at an online system, target entity raw data from a target entity, wherein the target entity raw data describes entity activities performed by the target entity;
identifying, for the target entity, a data framework corresponding to the target entity raw data, wherein the data framework describes a structure of the target entity raw data;
generating a data block based on the target entity raw data and the identified data framework, wherein the data block stores data from the target entity raw data in accordance with a common data schema;
storing the data block in a blockchain, wherein the blockchain comprises a plurality of data blocks storing target entity raw data from a plurality of target entities;
receiving an information request from an information client, wherein the information request identifies a data analysis process to perform one or more data blocks in the blockchain, wherein the one or more data blocks comprise the generated data block;
generating data analysis results by performing the data analysis process on the one or more data blocks; and
transmitting the data analysis results to the information client.

2. The method of claim 1, wherein generating the data block comprises mapping data fields from the identified data framework to data fields used by the common data schema.

3. The method of claim 1, wherein generating the data analysis results by performing the data analysis process comprises transmitting a subset of target entity raw data stored in the data block based on a layered permission process.

4. The method of claim 1, wherein storing the data block in the blockchain comprises encrypting the data block based on an encryption key.

5. The method of claim 1, wherein the data framework is identified based on a lookup table associating data frameworks with target entities.

6. The method of claim 1, wherein the data framework is identified by analyzing a structure of the target entity raw data.

7. The method of claim 1, wherein generating the data analysis results comprises verifying the one or more data blocks based on metadata stored in the blockchain.

8. A non-transitory computer-readable medium storing instructions that, when executed by a processor, cause the processor to:
receive, at an online system, target entity raw data from a target entity, wherein the target entity raw data describes entity activities performed by the target entity;
identify, for the target entity, a data framework corresponding to the target entity raw data, wherein the data framework describes a structure of the target entity raw data;
generate a data block based on the target entity raw data and the identified data framework, wherein the data block stores data from the target entity raw data in accordance with a common data schema;
store the data block in a blockchain, wherein the blockchain comprises a plurality of data blocks storing target entity raw data from a plurality of target entities;
receive an information request from an information client, wherein the information request identifies a data analysis process to perform one or more data blocks in the blockchain, wherein the one or more data blocks comprise the generated data block;
generate data analysis results by performing the data analysis process on the one or more data blocks; and
transmit the data analysis results to the information client.

9. The computer-readable medium of claim 8, wherein generating the data block comprises mapping data fields from the identified data framework to data fields used by the common data schema.

10. The computer-readable medium of claim 8, wherein generating the data analysis results by performing the data analysis process comprises transmitting a subset of target entity raw data stored in the data block based on a layered permission process.

11. The computer-readable medium of claim 8, wherein storing the data block in the blockchain comprises encrypting the data block based on an encryption key.

12. The computer-readable medium of claim 8, wherein the data framework is identified based on a lookup table associating data frameworks with target entities.

13. The computer-readable medium of claim 8, wherein the data framework is identified by analyzing a structure of the target entity raw data.

14. The computer-readable medium of claim 8, wherein generating the data analysis results comprises verifying the one or more data blocks based on metadata stored in the blockchain.

15. An online system comprising:
a processor; and
a non-transitory computer-readable medium storing instructions that, when executed by the processor, cause the processor to:
receive, at an online system, target entity raw data from a target entity, wherein the target entity raw data describes entity activities performed by the target entity;
identify, for the target entity, a data framework corresponding to the target entity raw data, wherein the data framework describes a structure of the target entity raw data;
generate a data block based on the target entity raw data and the identified data framework, wherein the data block stores data from the target entity raw data in accordance with a common data schema;
store the data block in a blockchain, wherein the blockchain comprises a plurality of data blocks storing target entity raw data from a plurality of target entities;
receive an information request from an information client, wherein the information request identifies a data analysis process to perform one or more data blocks in the blockchain, wherein the one or more data blocks comprise the generated data block;
generate data analysis results by performing the data analysis process on the one or more data blocks; and
transmit the data analysis results to the information client.

16. The online system of claim 15, wherein generating the data block comprises mapping data fields from the identified data framework to data fields used by the common data schema.

17. The online system of claim 15, wherein generating the data analysis results by performing the data analysis process comprises transmitting a subset of target entity raw data stored in the data block based on a layered permission process.

18. The online system of claim 15, wherein storing the data block in the blockchain comprises encrypting the data block based on an encryption key.

19. The online system of claim 15, wherein the data framework is identified based on a lookup table associating data frameworks with target entities.

20. The online system of claim 15, wherein the data framework is identified by analyzing a structure of the target entity raw data.
